(19) United States
(12) Patent Application Publication
(10) Pub. No.: US 2007/0278028 A1
(43) Pub. Date: Dec. 6, 2007

(54) Anti-aeration system for a suspension actuator

(76) Inventors: Wayne Robert Fought, Mt. Carmel, TN (US); Richard J. Barron, Ann Arbor, MI (US)

Correspondence Address: MACMILLAN, SOBANSKI & TODD, LLC, ONE MARITIME PLAZA - FOURTH FLOOR, 720 WATER STREET, TOLEDO, OH, 43604, US

(21) Appl. No.: 11/446,900

(22) Filed: Jun. 5, 2006

(51) Int. Cl. B60K 28/14

(52) U.S. Cl. 180/282

(57) ABSTRACT

A hydraulically operated actuator is provided for controlling a roll of a vehicle that includes an actuator connected between a first mass and a second mass of the vehicle. An upper mount assembly is coupled to the first mass and a lower mount assembly is coupled to the second mass. A high pressure chamber is disposed between the lower mount assembly and the upper mount assembly. The high pressure chamber has a variable volume of hydraulic fluid disposed therein for selectively restricting the movement between the upper mount assembly and the lower mount assembly. A low pressure accumulator includes a portal for receiving hydraulic fluid from the high pressure chamber. An anti-aeration assembly for minimizing gas bubbles from transitioning between the high pressure chamber and the accumulator, the anti-aeration assembly being disposed with the accumulator.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM LISTING COMPACT DISC APPENDIX

Not Applicable

### BACKGROUND OF THE INVENTION

1. Field of the Invention

The present-invention relates in general to a suspension system, and more specifically, to an anti-aeration system in a roll control actuator.

2. Description of the Related Art

Suspension systems for a motor vehicle are known which isolate the vehicle from irregularities in the road terrain over which the vehicle travels. Suspension systems typically include a sway bar which couples the suspension on each side of a vehicle to one another. The sway bar assists in maintaining even compression on each side of the vehicle suspension. For a vehicle in a cornering maneuver having no sway bar, one side of a vehicle suspension will be under compression and the other side will have no or very little compression applied. For a vehicle having a sway bar, compression is maintained on both sides of the vehicle during a cornering maneuver. Maintaining compression on the inside vehicle wheel going about a turn minimizes the chances of the vehicle wheel lifting off the ground.

A semi-active suspension system normally includes a spring and damper connected between the sprung portions (e.g. sway bar) and unsprung portions (vehicle frame) of the vehicle. Semi-active suspension systems are generally self-contained, and only react to the loads applied to them. In active suspension systems, by contrast, the reactions to the applied loads are positively supplied, typically by electronically controlled hydraulic or pneumatic actuators.

An actuator for a semi-active suspension system utilizes a spring biased piston assembly in cooperation with the self-contained hydraulic fluid chambers (damper) for dampening sudden deflections in the suspension system caused by deflection in the road terrain and for maintaining a rigid suspension system when cornering. The actuator utilizes a high pressure chamber and a storage chamber for transferring hydraulic fluid within the actuator for allowing the compression of the actuator. The high pressure chamber is formed about the piston assembly and maintains a resistive force on the spring biased piston for gradually controlling the axial movement of the actuator. When in a dampening mode, hydraulic fluid is allowed to flow from the high pressure chamber to the storage chamber via the compression force exerted on the actuator. The resistive force of the spring biased piston and the withdrawal of hydraulic fluid from the high pressure chamber provides for a gradual smooth movement of the actuator. When the force is no longer applied to the actuator, the spring biased piston uncompresses and moves back to its extended position. As the piston moves back to the extended position, hydraulic fluid flows from the storage chamber to the high pressure chamber via a vacuum created by the piston assembly which provides a gradual return to its extended position.

For straight road driving, a solenoid valve is in an open position for allowing hydraulic fluid to exit the high pressure chamber of the actuator which allows the actuator to compress and dampen deflections in the suspension system. When a vehicle is cornering, the solenoid valve is in a closed position for preventing hydraulic fluid from leaving the high pressure chamber. This prevents the actuator from compressing so that a rigid suspension system is maintained.

As the vehicle travels over uneven terrain (with the solenoid valve in the open position), the actuator constantly compresses and uncompresses, thereby forcing hydraulic fluid in and out of both the high pressure chamber and the storage chamber. Gas within the hydraulic fluid of the storage chamber is produced when the hydraulic fluid jets into the storage chamber and breaks the surface of the hydraulic fluid therein. The storage chamber is typically filled with a gas, such as nitrogen. If hydraulic fluid is allowed to jet into the storage chamber and break the surface of the hydraulic fluid in the storage chamber, gas bubbles will be produced within the hydraulic fluid. Hydraulic fluid is non-compressible; however as gas bubbles are mixed into the hydraulic fluid, the hydraulic fluid within the high pressure chamber becomes compressible due to the gas bubbles being compressible. The gas bubbles allow for compression in the high pressure chamber even when the solenoid valve is in a closed position. This reduces the rigidity of the suspension system when a rigid suspension system is desired.

### BRIEF SUMMARY OF THE INVENTION

The present invention has the advantage of utilizing a flow diverter in a roll control actuator for preventing gas bubbles from forming in a low pressure accumulator as pressurized hydraulic fluid is transferred from a high pressure chamber to the low pressure accumulator.

In one aspect of the present invention, a hydraulically operated actuator is provided for controlling a roll of a vehicle. The actuator is connected between a first mass of the vehicle and a second mass of the vehicle. An upper mount assembly is coupled to the first mass of the vehicle. A lower mount assembly is coupled to the second mass of the vehicle. A variable high pressure chamber is disposed between the lower mount assembly and the upper mount assembly, the variable high pressure chamber having a variable volume of hydraulic fluid disposed therein for selectively dampening the movement between the upper mount assembly and the lower mount assembly. A low pressure accumulator includes a portal for receiving hydraulic fluid from the high pressure chamber. The hydraulic fluid is in fluid communication between the high pressure chamber and the accumulator. An anti-aeration assembly for minimizing gas bubbles from transitioning between the high pressure chamber and the accumulator, the anti-aeration assembly being disposed within the accumulator.

In yet another aspect of the present invention, an actuator assembly is provided for controlling vehicle suspension rigidity. The actuator includes an upper mount assembly coupled to a suspension member. A lower mount assembly is coupled to a vehicle frame. A piston assembly includes a piston rod and a piston. The piston rod is coupled to the upper mount assembly for maintaining a variably spaced relationship between the upper mount assembly and the lower mount assembly. An accumulator is disposed between the upper mount assembly and the lower mount assembly for storing a variable amount of hydraulic fluid. The accumulator includes a first portal for receiving hydraulic fluid flow into the accumulator. A high pressure chamber contains hydraulic fluid, the high pressure chamber being selectively compressible. A solenoid valve is interposed between the high pressure chamber and the accumulator for selectively controlling pressure within the high pressure chamber by controlling the fluid flow from the high pressure chamber to the accumulator. The solenoid valve when in an open position allows fluid flow from the high pressure chamber to the accumulator as the high pressure chamber is compressed. A flow diverter within the accumulator directs a flow of hydraulic fluid flow from the high pressure chamber to the accumulator. The flow diverter minimizes the hydraulic fluid flow into the accumulator from forming gas bubbles in the hydraulic fluid.

In yet another aspect of the invention, an anti-aeration system is provided for a gas and fluid filled reservoir in a hydraulic suspension actuator. The actuator is hydraulically operated for controlling a roll of a vehicle. The actuator is connected between a first mass of the vehicle and a second mass of the vehicle. The actuator includes an upper mount assembly coupled to the first mass of the vehicle and a lower mount assembly coupled to the second mass of the vehicle. A high pressure chamber is disposed between the lower mount assembly and the upper mount assembly. The high pressure chamber has a variable volume of hydraulic fluid disposed therein for selectively dampening the movement between the upper mount assembly and the lower mount assembly. A low pressure accumulator includes a first portal for selectively receiving hydraulic fluid from the high pressure chamber and a second portal disposed on a bottom surface of the accumulator for allowing hydraulic fluid to exit from the accumulator to the high pressure chamber. A flow diverter for redirecting a flow of hydraulic fluid within the accumulator minimizes the formation gas bubbles in the hydraulic fluid within the accumulator. A fence portion is disposed around the second portal for minimizing gas bubbles suspended in the hydraulic fluid of the accumulator from entering the second portal.

Various objects and advantages of this invention will become apparent to those skilled in the art from the following detailed description of the preferred embodiment, when read in light of the accompanying drawings.

### BRIEF DESCRIPTION OF THE DRAWINGS

FIG. 1 is an exploded perspective view of the actuator according to a first preferred embodiment of the present invention.

FIG. 2 is partial cross section view of the actuator according to the first preferred embodiment of the present invention.

FIG. 3 is an enlarged view of the encircled portion of FIG. 1 according to the first preferred embodiment of the present invention.

FIG. 4 is a perspective view of a flow diverter according to a second preferred embodiment of the present invention.

FIG. 5 is a perspective view of a flow diverter according to a third preferred embodiment of the present invention.

FIG. 6 is a perspective view of a flow diverter according to a fourth preferred embodiment of the present invention.

FIG. 7 is a perspective view of a flow diverter according to a fifth preferred embodiment of the present invention.

FIG. 8 is a perspective view of a flow diverter according to a sixth preferred embodiment of the present invention.

FIG. 9 is a perspective view of a portion of an accumulator according to a seventh preferred embodiment of the present invention.

FIG. 10 is a perspective view of a portion of an accumulator according to an eighth preferred embodiment of the present invention.

FIG. 11 is a perspective view of a portion of an accumulator according to a ninth preferred embodiment of the present invention.

### DETAILED DESCRIPTION OF THE PREFERRED EMBODIMENT

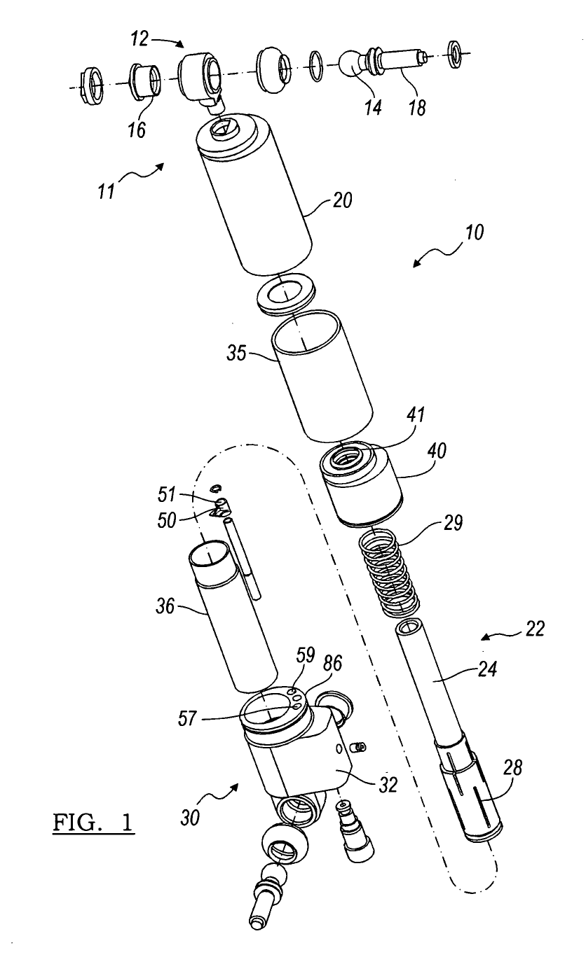

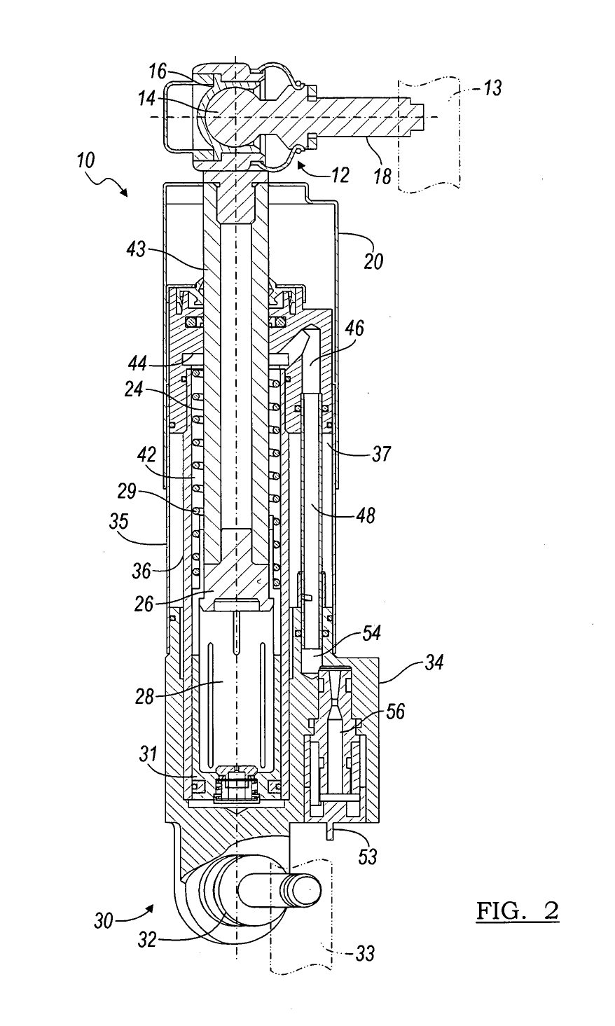

Referring now to the drawings, there is illustrated in FIGS. 1 and 2 a self-contained hydraulic fluid actuator 10 for a semi-active roll control system. The actuator 10 includes an upper mount assembly 11 for attachment to a first mass 13 of a vehicle such as a vehicle frame member. The upper mount assembly 11 includes an upper ball joint assembly 12 having a pivot ball 14 interconnected to a socket 16 which allows for circumferential movement of the actuator 10 in relation to the attaching vehicle frame member. The pivot ball 16 is also coupled to a pivot shaft 18 for attachment to the vehicle frame member.

The upper mount assembly 11 also includes a dust cover 20. The dust cover 20 functions as a protective guard against debris (e.g., stones) from the road that may cause damage to any underlying components of the actuator 10. A piston assembly 22 is also coupled to the upper mount assembly 11. The piston assembly 22 includes a piston rod 24, a piston rod head 26, a piston 28, and a piston spring 29. The piston rod 24 is coupled to the piston rod head 26 (e.g., threaded) or may be formed integral as one component. The piston 28 includes a check valve assembly 31 coupled to a bottom surface of the piston 28. Preferably, the piston 28 is a free floating piston which is slideable over the piston rod head 26 as described in co-pending application U.S. Ser. No. 10/892,484 filed Jul. 16^{th}, 2004, which is incorporated herein by reference.

The actuator 10 further includes a lower mount assembly 30. The lower mount assembly 30 includes a fastening member 32 coupled to a first mass 33 of the vehicle such as a sway bar (sprung member). The lower mount assembly 30 further includes a lower housing portion 34. An inner tubular member 36 spaced radially outward from the piston assembly 22 extends into the lower housing portion 34 and is coupled to the lower housing portion 34 therein. An outer tubular member 35 spaced radially outward from the inner tubular member 36 is sealing engaged to the lower housing portion 34. A low pressure accumulator 37 is formed between the outer tubular member 35 and the inner tubular member 36. The accumulator 37 is partially filled with hydraulic fluid and partially filled with a gas, such as nitrogen. A high pressure chamber 42 is formed between the inner tubular member 36 and the piston assembly 22.

A cap assembly 40 is seated on top of the outer tubular member 35 and the inner tubular member 36. The cap assembly 40 includes a centered aperture 43 for receiving the piston rod 24 axially therethrough for attachment to the upper mount assembly 11. The piston spring 29 extends axially around the piston rod 24. The ends of the piston spring 29 are bound by an abutment portion 44 of the upper cap assembly 40 and an abutment portion 46 of the piston 28.

The cap assembly 40 is disposed above the high pressure chamber 42 and is in fluid communication with the high pressure chamber 42. The cap assembly 40 includes a fluid conduit 46 that coupled to a transfer tube 48 disposed within the accumulator 37. Pressurized hydraulic fluid exits from the top of the high pressure chamber 42 via the first conduit 46 and is provided to the transfer tube 48. The transfer tube 48 extends between the upper cap assembly 40 and the lower housing assembly 34 within the accumulator 37 for allowing fluid flow between the upper cap assembly 40 and a solenoid valve 56 disposed in the lower housing assembly 34.

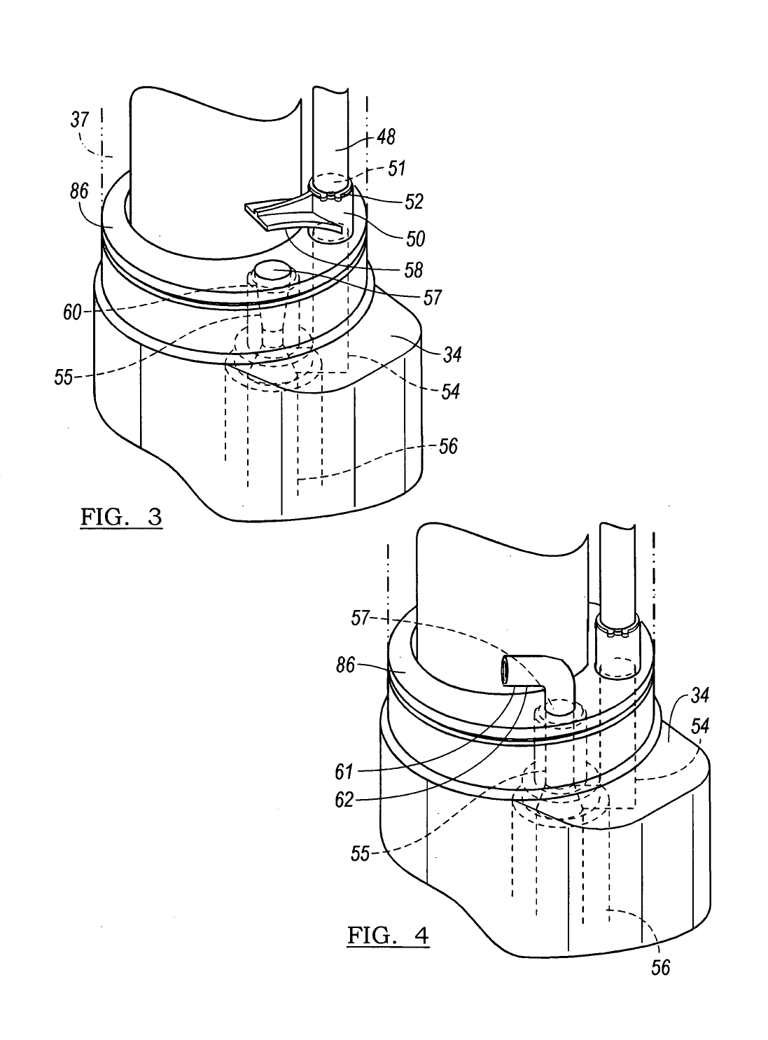

Referring to FIG. 3, a flow deflector 50 is disposed within the accumulator 37 above a portal 57. The flow deflector 50 includes a bore 51 for receiving the transfer tube 48 therethrough. The bore 51 of the flow deflector 50 is slideable over the exterior surface of the transfer tube 48. The flow deflector 50 is secured to the transfer tube 48 by attaching a retaining ring 52 in a grooved section of the transfer tube 48 for locating the flow deflector 50 on the transfer tube 48 at a desired location within the accumulator 37. The flow deflector 50 functions as a bushing for locating the transfer tube 48 when the transfer tube 48 is aligned and inserted into the lower housing assembly 34.

The lower housing assembly 34 further includes a first passageway 54 that fluidically connects the transfer tube 48 to the solenoid valve 56 disposed within the lower housing assembly 34. A second passageway 55 fluidically connects the accumulator 37 to the solenoid valve 56. The solenoid valve 56 includes electrical leads 53 (shown in FIG. 2) that receive power to energize the solenoid valve 56 to an open or closed position for allowing hydraulic fluid flow between the first passageway 54 and the second passageway 55. When the solenoid valve 56 is actuated to allow hydraulic fluid flow from the high pressure chamber 42 to the accumulator 37, pressurized hydraulic fluid jets through the portal 57 leading into the accumulator 37. Preferably, the flow passages from passageway 54 to passageway 55 includes a convergence/divergence section for increasing pressure and decreasing fluid flow rate to produce a venturi action for reducing the jet stream and turbulence and placing a backpressure on the solenoid valve 56. A diverging portion 60 includes a gradual widened opening for decreasing fluid flow rate into the accumulator 37. The gradual widened opening extending to the first portal 59 functions to decelerate the fluid flow rate and gradually allow the fluid flow to reach a substantially same pressure as that in the accumulator 37.

A portion of the flow deflector 50 is positioned directly above the portal 57 for preventing hydraulic fluid from jetting above the surface of the hydraulic fluid stored in the accumulator 37. Preventing the jetted hydraulic fluid from breaching the surface of the hydraulic fluid within the accumulator 37 substantially reduces the formation of gas bubbles within the hydraulic fluid.

A controller (not shown) provides control signals to energize the solenoid valve 56 between the open or closed position depending on the vehicle operating conditions. The controller senses a plurality of operating conditions, including but not limited to speed, lateral acceleration, and steering wheel angle. A semi-active roll control algorithm will process the information and, based on the sensed inputs, will produce a control command indicating whether to close or open the solenoid valve 56 for maintaining a rigid or non-rigid suspension system.

As the force exerted on the lower mount assembly 30 is removed, the piston spring 29 uncompresses and forces the piston 28 back to an extended position (or centered position). As the piston transitions from a compressed position to the extended position, the positioning of the piston in cooperation with a pressure differential causes hydraulic fluid to be drawn from the accumulator 37 back into the high pressure chamber 42. Hydraulic fluid is drawn from the accumulator 37 to the high pressure high pressure chamber 42 by a second portal 59 (shown in FIG. 1). The second portal 59 is disposed on a bottom surface 86 of the accumulator 37. The second portal 59 allows fluid to flow from the accumulator 37 to the high pressure chamber 42 depending on the pressure differential and the placement of the piston.

The flow deflector 50 includes a substantially arc-shaped underbody surface 58. The flow deflector 50 is positioned over the portal 57 of the second passageway 55. Hydraulic fluid forced into the accumulator 37 under high pressure from the portal 57 jets into the accumulator 37 in a vertical upward direction. The jetted hydraulic fluid is gradually deflected in a substantially horizontal direction by the arc-shaped underbody surface 58 of the flow deflector 50. Thus, the deflected hydraulic fluid flows in a horizontal circular direction and is prevented from flowing upward and breaching the surface of the existing hydraulic fluid within the accumulator 37. Preventing the jetted hydraulic fluid from breaking the surface of the hydraulic fluid minimizes the gas bubbles within the hydraulic fluid in the accumulator 37.

FIG. 4 illustrates an enlarged view of a flow diverter 61 attached to the lower housing portion 34 according to a second preferred embodiment. The flow diverter 61 includes an arc-shaped fluid conduit 62 extending from the portal 57 of the second passageway 55. The fluid conduit 62 curves from a vertical direction to a substantially horizontal direction. Fluid jetting from the portal 57 of the second passageway 55 enters the flow diverter 61 and is redirected in a substantially horizontal direction. This prevents the hydraulic fluid exiting the flow diverter 61 from flowing in a direction which could break the surface of the hydraulic fluid stored within the accumulator 37, thus minimizing the gas bubbles therein.

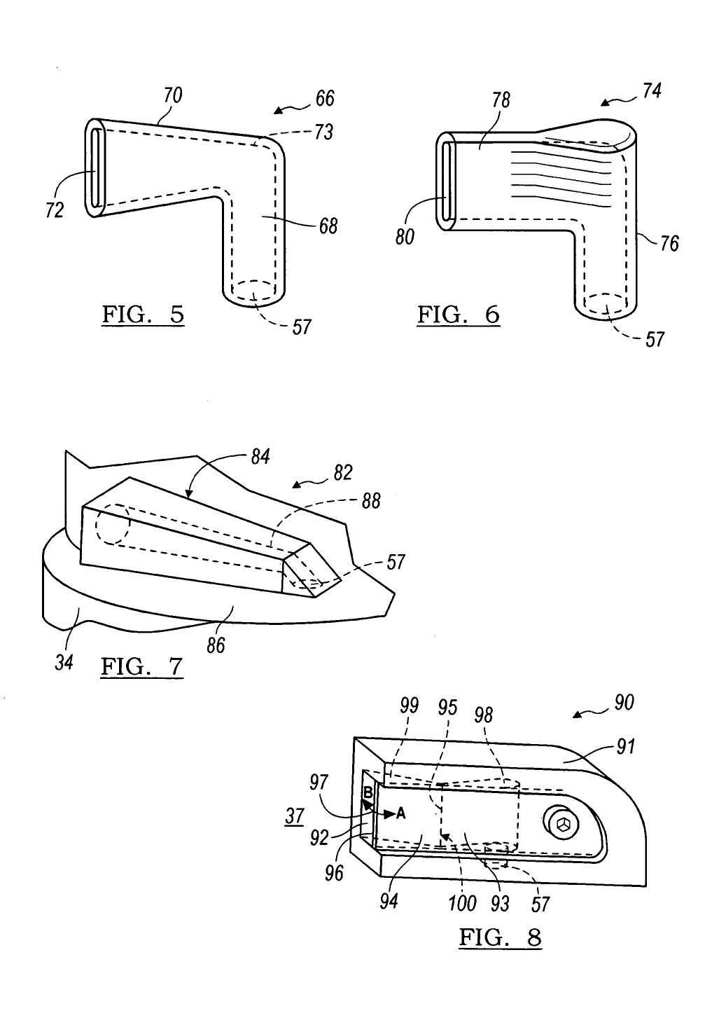

FIG. 5 is a third embodiment illustrating a flow diverter 66 for diverting the hydraulic fluid flow entering the accumulator 37 (such as one shown in FIGS. 2 and 3). The flow diverter 66 includes a vertical tubular section 68 which is coupled to the portal 57 of the second passageway 55 (not shown in this figure). A flattened tubular section 70 extends substantially 90 degrees from the vertical tubular section 68. An opening 72 of the flattened tubular section 70 includes a flattened widened mouth. The flow diverter 66 is preferably made of an elastomeric material such as rubber, but may be made of other types of materials if so desired. Fluid entering the accumulator 37 is directed in a substantially horizontal direction for preventing it from breaking the surface of the hydraulic fluid, thus minimizing gas bubbles in the hydraulic fluid. The flow diverter 66 functions as a venturi for hydraulic fluid flowing between the accumulator 37 and the high pressure chamber 42 (not shown in this figure). A narrowed neck section 73 between the vertical tubular section 68 and the widened mouth opening 72 functions as a convergent/divergent section for creating a venturi effect.

The flow diverter 66, if made of an elastomeric material, also has the advantage of functioning like a check valve for preventing the return of hydraulic fluid from the accumulator 37 to the high pressure chamber 42 via the flow diverter 66. In the unlikelihood of a small amount of gas bubbles formed in the hydraulic fluid of the accumulator 37, gas bubbles could return to the high pressure chamber 42 via the perspective flow diverter. That is, gas bubbles formed in the liquid float upward; however, because of the viscosity of the hydraulic fluid (e.g., oil), the gas bubbles may not disperse above the surface of the hydraulic fluid in a timely manner that would be warranted. Rather, the gas bubbles may be slow to float to the surface and may remain suspended in the hydraulic fluid. Under such conditions, a respective flow diverter having an opening at a respective height above the bottom surface of the accumulator 37 may be susceptible to allowing gas bubbles suspended within the hydraulic fluid to flow therein to the high pressure chamber 42. Unlike portal 57 disposed on the bottom surface 86 of the accumulator 37, as shown in FIG. 3, respective flow diverters extending into the accumulator 37 and having their respective portal openings at an elevated distance above the bottom surface 86 of the accumulator 37 are susceptible to allowing gas bubbles suspended in the accumulator 37 to flow to the high pressure chamber 42 back through the respective flow diverter. This is primarily due to a respective flow diverter having an elevated opening in a region of the accumulator 37 where gas bubbles may be suspended. The flow diverter 66, as shown in FIG. 5, prevents hydraulic fluid flow from re-entering the opening 72 of the flow-diverter 66 as a result of the geometric shape of the tubular section 70 and its elastomeric properties. A vacuum flow created from the accumulator 37 to the high pressure chamber 42 would cause the opening 72 to close and seal itself thereby restricting reverse flow through the flow diverter 66. Fluid returning to high pressure chamber 42 would exit the accumulator 37 via the second portal 59 (shown in FIG. 1) disposed on the bottom surface of the accumulator 37.

FIG. 6 is a flow diverter 74 according to a fourth preferred embodiment of the present invention. The flow diverter 74 is similar to the flow diverter 66 of FIG. 4. The flow diverter 74 includes a vertical tubular section 76 which extends into the opening 57 of the second passageway 55 (not shown in this figure). A flattened tubular section 78 extends substantially 90 degrees from the vertical tubular section 76. Fluid entering the accumulator 37 (now shown in this figure) is directed in a substantially horizontal direction, preventing the in-flowing hydraulic fluid from breaking the surface, thus minimizing gas bubbles in the hydraulic fluid. The flattened tubular section 78 includes a flattened uniform section that extends laterally to an opening 80. The flow diverter 74 resembles that of Bunsen valve. A vacuum flow created from the accumulator 37 to the high pressure chamber 42 (not shown in this figure) causes the opening 80 to close and seal itself thereby restricting reverse flow through the flow diverter 74.

FIG. 7 shows a flow diverter 82 according to a fifth preferred embodiment of the present invention. The flow diverter 82 may be integral to the lower housing portion 34. The flow diverter 82 includes a tubular segment 84 that extends laterally along the bottom surface 86 of the accumulator 37 (not shown in this figure). The flow diverter 82 includes a substantially horizontal passageway 88 which extends from the opening 57 of the second passageway 55 (not shown in this figure) to the accumulator 37. Hydraulic fluid exiting the flow diverter 82 is directed in a substantially horizontal direction into the accumulator 37, thereby minimizing gas bubbles in the hydraulic fluid in the accumulator 37 that would otherwise be formed if the incoming hydraulic fluid broke the surface of the hydraulic fluid within the accumulator 37. The flow diverter 82 can be seated low with respect to the bottom surface 86 when formed integral with the lower housing portion 34. This minimizes the return of entrapped gas bubbles suspended in the hydraulic fluid from flowing through the flow diverter 82 since entrapped gas is typically not suspended close to the bottom surface 86.

FIG. 8 shows a flow diverter 90 according to a sixth preferred embodiment of the present invention. The flow diverter 90 may be integral to the lower housing portion 34 or may be separately formed and coupled thereafter to the lower housing portion 34. The flow diverter 90 includes a main body portion 91. The main body portion 91 includes a wall section 92 that that has a first sloping surface 93 and a second sloping surface 94. The first sloping surface 93 and the second sloping surface 94 intersect at an apex 95.

A reed valve 96 is coupled to the main body 91 and extends laterally along the wall section 92. The reed valve 96 is made of an elastomeric material, such as rubber, which allows the reed valve 96 to move the directions as shown by the direction indicator 97 when respective forces are exerted on the reed valve 96. When no forces are acting on the reed valve 96, a portion of the reed valve 96 abuts the apex 95. Alternatively, the reed valve 96 may be positioned so that the reed valve 96 is in close proximity to the apex 95.

A first chamber portion 98 is cooperatively formed by the first sloping surface 93 and reed valve 96. The first chamber portion 98 is disposed above the portal 57 and is in fluid communication with the portal 57. The first chamber 92 widens as it extends along the first sloped surface 93 from the apex 95 to an opposing end portion of the first chamber portion 98 that is in fluid communication with the portal 57.

A second chamber portion 99 is cooperatively formed by the second sloping surface 94 and reed valve 96. The second chamber portion 99 widens as it extends from its apex 95 to an opposing end of the second chamber portion 99 that is in fluid communication with the accumulator 37.

A narrowed passageway 100 is formed between the apex 95 and the opposing section of the reed valve 96 which allows fluid flow from the first chamber portion 98 to the second chamber portion 99. When hydraulic fluid is forced from high pressure chamber 42 (not shown) to the accumulator 37, pressurized hydraulic fluid is forced into the first chamber portion 98 via portal 57. As fluid flow increases into the first chamber portion 98, pressure builds into the tapered portion of the first chamber portion 98 to force the reed valve 96 in the direction A as indicated by the direction indicator 97. As fluid flows through the narrowed passageway 100, fluid flow increases as pressure decreases. Hydraulic fluid flows into the second chamber portion 99. The second chamber portion 99 widens as fluid flows from the apex 95, and thereafter, into the accumulator 37. As fluid flows into the widening second chamber portion 99, fluid flow decreases and pressure increases thereby reducing abrupt pressure changes and minimizing the jetting fluid and turbulence.

The hydraulic fluid entering the accumulator 37 from the second chamber portion 99 is forced in a substantially horizontal direction which prevents hydraulic fluid from jetting above the surface of the hydraulic fluid thereby minimizing the formation of gas bubbles within the hydraulic fluid of the accumulator 37.

When hydraulic fluid returns to the high pressure chamber 42 from the accumulator 37, fluid flow is prevented from re-entering the flow diverter 90. As fluid attempts to re-enter the flow diverter 90 from the accumulator 37, a vacuum is created from the high pressure chamber 42. The vacuum attempts to draw fluid from the accumulator 37 into the second chamber portion 99. In response to the vacuum created by the reverse fluid flow, the reed valve 96 is forced in the direction B as indicated by the direction indicator 97. The portion of the reed valve 96 collapses against the second sloped surface 93 and the apex 95 thereby stopping any additional hydraulic fluid from passing through flow diverter 90 and to the high pressure chamber 42. Any gas bubbles suspended within the hydraulic fluid which may have formed are prevented from flowing to the high pressure chamber 42 through the flow diverter 90.

It should be noted gas bubbles suspended in the high pressure chamber 42 exit the high pressure chamber 42 via first conduit 46 coupled to the top of the high pressure chamber 42. The gas bubbles travel through the transfer tube 48 and into the accumulator via the first portal 57 where the hydraulic fluid and gas bubbles disposed therein are redirected in the substantially horizontal direction by a respective flow diverter. These gas bubbles circulate within the accumulator 37 and gradually rise to the top surface as the hydraulic fluid flow rate decreases within the accumulator 37 thereby purging the gas bubbles within the high pressure chamber 42.

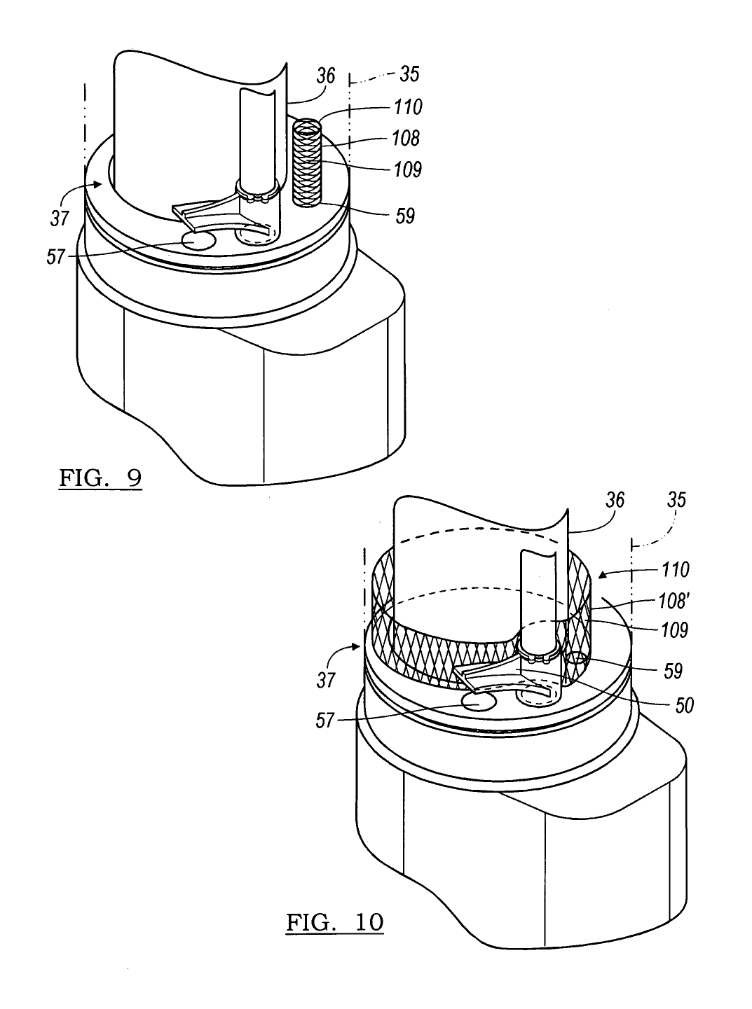

FIG. 9 shows a perspective view of a portion of the accumulator 37 according to a seventh preferred embodiment of the present invention. The accumulator 37 includes a portal 57 for allowing pressurized hydraulic fluid to enter the accumulator 37 from the high pressure chamber 42 (shown in FIG. 2). A portion of the flow deflector 50 is positioned directly above the portal 57 for preventing hydraulic fluid from jetting above the surface of the hydraulic fluid stored in the accumulator 37. Preventing the jetted hydraulic fluid from breaching the surface of the hydraulic fluid within the accumulator 37 substantially reduces the formation of gas bubbles within the hydraulic fluid.

A fence portion 108 is disposed around the second portal 59 and extends vertically upward into the accumulator 37. The fence portion 108 includes a mesh-type material having mesh-like openings 109 that allows for fluid flow therethrough. As fluid exits from the accumulator 37 through the second portal 59, hydraulic fluid is drawn through fence portion 108. The fence portion 108 screens gas bubbles suspended within the hydraulic fluid of the accumulator 37 as the hydraulic fluid passes through the fence portion 108 thereby minimizing gas bubbles from flowing through the second portal 59 and to the high pressure chamber 42.

The fence portion 108 may be extended to only a predetermined height for allowing flow over in the event the hydraulic fluid becomes highly viscous. Under certain conditions (e.g., cold weather), the hydraulic fluid within the accumulator 37 may have high viscosity. Depending upon the size of the mesh openings of the fence portion 108, hydraulic fluid may be restricted from flowing through the mesh openings of the fence portion 108 or may flow at a very slow rate. By limiting the height of the fence portion 108, the fence portion 108 may function as a weir for allowing hydraulic fluid to flow over a top unrestricted opening 110 of the fence portion 108 should the hydraulic fluid be too viscous to flow through the mesh-type openings 109 of the fence portion 108.

FIG. 10 shows a perspective view of an anti-aeration assembly according to an eighth preferred embodiment of the present invention. The accumulator 37 includes the second portal 59 for allowing pressurized hydraulic fluid to enter the accumulator 37 from the high pressure chamber 42

Referring to FIG. 9, during cold temperatures, the viscosity of the hydraulic fluid within the accumulator rises. The thickness of the hydraulic fluid during the cold temperatures may not allow the hydraulic fluid to flow through the mesh-like openings 109. In addition, having to too little of an existing volume of fluid within the fence portion 108 may deplete the hydraulic fluid from this region within the fence portion 108, and as a result, gas may be drawn into the second portal 57 and to the high pressure accumulator 42.

Referring again to FIG. 10, an anti-aeration system is shown for maintaining a sufficient volume of hydraulic fluid with the fence portion 108′. The fence portion 108′ is disposed radially outward and around the inner tubular member 36. The second portal 59 is disposed on the bottom surface of the accumulator between the fence portion 108′ and the inner tubular member 36. The fence portion 108′ extends to only a predetermined height above the second portal 59. As stated earlier, under cold weather conditions, the hydraulic fluid within the accumulator 37 may be too thick to flow through the mesh-like opening 109 of the fence portion 108′. When hydraulic fluid enters the accumulator 37 from the first portal 57, hydraulic fluid fills the region between the outer tubular member 35 and the fence portion 108′. As the hydraulic fluid reaches the top of the fence portion 108′, the fence portion 108′ functions as a weir by allowing hydraulic fluid to flow over a top unrestricted opening 110 of the fence portion 108′ and into the region between inner tubular member 36 and the fence portion 108′. The region between the fence portion 108′ and the inner tubular member 36 is sufficient so that when fluid is drawn out via the second portal 59, the hydraulic fluid with this region is not depleted when exiting the second portal 59.

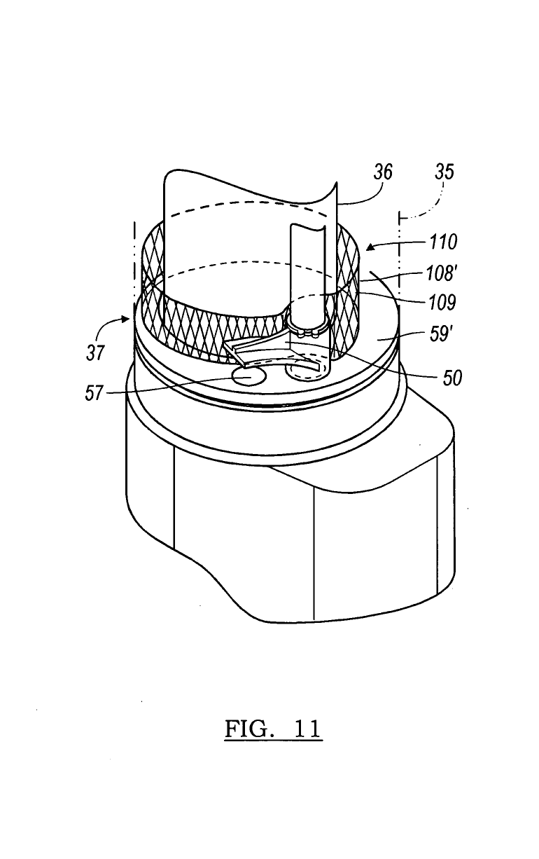

FIG. 11 shows a perspective view of an anti-aeration assembly according to a ninth preferred embodiment of the present invention. In this embodiment, a second portal 59′ is disposed centrally about the inner tubular member 36 along the bottom surface of the accumulator 37 juxtaposed to the high pressure accumulator 42. As hydraulic fluid enters the accumulator 37 when the hydraulic fluid is cold and viscous, hydraulic fluid is allowed to flow over the top of the fence portion 108′ for maintaining a sufficient volume of fluid within this region so that gas is unable to exit through the second portal 59.

In alternative embodiments, a respective fence portion may be designed utilizing difference diameters, heights, and geometrical configurations based on the size, location, and shape of a respective second portal. In addition, the fence portion can be utilized with the various embodiments of flow diverters as discussed above. Moreover, the centrally disposed second portal 59′ may be utilized without a respective fence since gas bubbles have a tendency to float upward and away from the lower central portion of the accumulator.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

What is claimed is:

1. A hydraulically operated actuator for controlling a roll of a vehicle, said actuator being connected between a first mass of said vehicle and a second mass of said vehicle, said actuator comprising:
an upper mount assembly coupled to said first mass of said vehicle;
a lower mount assembly coupled to said second mass of said vehicle;
a high pressure chamber disposed between said lower mount assembly and said upper mount assembly, said high pressure chamber having a variable volume of hydraulic fluid disposed therein for selectively dampening said movement between said upper mount assembly and said lower mount assembly;
a low pressure accumulator including a first portal for selectively receiving hydraulic fluid from said high pressure chamber; and
an anti-aeration assembly for minimizing gas bubbles from transitioning between said high pressure chamber and said accumulator, said anti-aeration assembly being disposed within said accumulator.

2. The actuator of claim 1 wherein said anti-aeration assembly includes a flow diverter for redirecting fluid flow within said accumulator for minimizing the formation of gas bubbles in the hydraulic fluid within said accumulator.

3. The actuator of claim 2 wherein said flow diverter includes a deflector for redirecting fluid flow within said accumulator.

4. The actuator of claim 3 wherein said deflector includes an angled surface area that redirects said hydraulic fluid flow entering said accumulator in a substantially horizontal direction.

5. The actuator of claim 3 wherein said deflector includes a non-linear surface that redirects said hydraulic fluid flow entering said accumulator in a substantially horizontal direction.

6. The actuator of claim 3 wherein at least a portion of said deflector is positioned over said first portal for preventing fluid flow from breaking a surface of said hydraulic fluid stored in said accumulator.

7. The actuator of claim 2 wherein said flow diverter includes a shaped conduit fluidically coupled to said first portal for redirecting said fluid flow from an upward direction to a substantially horizontal direction in said accumulator.

8. The actuator of claim 7 wherein said shaped conduit includes a curved portion for redirecting said hydraulic fluid flow entering said accumulator in a substantially horizontal direction.

9. The actuator of claim 7 wherein said shaped conduit includes a right angle bend for redirecting said hydraulic fluid flow entering said accumulator in a substantially horizontal direction.

10. The actuator of claim 7 wherein said shaped conduit flattens at an open end into said accumulator.

11. The actuator of claim 10 wherein said shaped conduit diverges at an open end into said accumulator.

12. The actuator of claim 11 wherein said flow diverter functions as a venturi for slowing said hydraulic fluid flow entering said accumulator.

13. The actuator of claim 10 wherein said shaped conduit is made of an elastomeric material.

14. The actuator of claim 7 wherein said shaped conduit is integrally formed as a part of said first portal, said shaped conduit extending in a substantially horizontal direction.

15. The actuator of claim 1 further comprising a second portal disposed on a bottom surface of said accumulator for allowing hydraulic fluid to exit said accumulator to said high pressure chamber.

16. The actuator of claim 15 wherein said second portal is centrally formed on said bottom surface of said accumulator juxtaposed to said high pressure accumulator.

17. The actuator of claim 15 wherein said anti-aeration assembly includes a fence portion disposed around said second portal for minimizing gas bubbles suspended in said hydraulic fluid of said accumulator from entering said second portal.

18. The actuator of claim 17 wherein said fence portion functions as a weir during cold temperature operations.

19. The actuator of claim 1 further comprising a transfer tube with a check valve fluidically coupled between said high pressure chamber and said accumulator, said check valve preventing a return of said hydraulic fluid from said accumulator to said high pressure chamber via said transfer tube.

20. An actuator assembly for controlling vehicle suspension rigidity, said actuator including an upper mount assembly coupled to a suspension member and a lower mount assembly coupled to a vehicle frame, a piston assembly including a piston rod and a piston, said piston rod being coupled to said upper mount assembly for maintaining a variably spaced relationship between said upper mount assembly and said lower mount assembly, said actuator assembly comprising:
an accumulator disposed between said upper mount assembly and said lower mount assembly for storing a variable amount of hydraulic fluid, said accumulator including a first portal for receiving hydraulic fluid flow into said accumulator;
a high pressure chamber containing hydraulic fluid, said high pressure chamber being selectively compressible;
a solenoid valve interposed between said high pressure chamber and said accumulator for selectively controlling pressure within said high pressure chamber by controlling said fluid flow from said high pressure chamber to said accumulator, and said solenoid valve when in an open position allows fluid flow from said high pressure chamber to said accumulator as said high pressure chamber is compressed; and
a flow diverter for directing a flow of hydraulic fluid flow, from said high pressure chamber to said accumulator, within said accumulator, said flow diverter minimizing said hydraulic fluid flow into said accumulator from forming gas bubbles in said hydraulic fluid.

21. The actuator assembly of claim 20 wherein said flow diverter includes a deflector for redirecting fluid flow within said accumulator.

22. The actuator assembly of claim 21 wherein said deflector includes an angled surface area that redirects said hydraulic fluid flow entering said accumulator in a substantially horizontal direction.

23. The actuator assembly of claim 21 wherein said deflector includes a non-linear surface that redirects hydraulic fluid flow from an upward direction to a substantially horizontal direction.

24. The actuator assembly of claim 21 wherein at least a portion of said deflector is positioned over said first portal for preventing fluid flow from breaking a surface of said hydraulic fluid stored in said accumulator.

25. The actuator assembly of claim 21 further comprising a transfer tube passing through said accumulator for providing a fluid passageway between said high pressure chamber and said solenoid valve, wherein said deflector is coupled to an exterior of said transfer tube within said accumulator.

26. The actuator assembly of claim 25 further comprising a fluid conduit coupled between said high pressure accumulator and said transfer tube for providing pressurized hydraulic fluid from said high pressure chamber to said transfer tube, said fluid conduit coupled to a top of said high pressure chamber.

27. The actuator assembly of claim 25 wherein said deflector functions as a spacer for positioning said transfer tube within said accumulator when being assembled between said high pressure chamber and said solenoid valve.

28. The actuator assembly of claim 20 wherein said flow diverter includes a shaped conduit fluidically coupled to said first portal for redirecting said fluid flow from an upward direction to a substantially horizontal direction in said accumulator.

29. The actuator assembly of claim 28 wherein said shaped conduit includes a curved portion for redirecting said fluid flow from said upward direction to said substantially horizontal direction.

30. The actuator assembly of claim 28 wherein said shaped conduit includes a right angle bend for redirecting said fluid flow from said upward direction to said substantially horizontal direction.

31. The actuator assembly of claim 30 wherein said shaped conduit diverges at an open end into said accumulator.

32. The actuator assembly of claim 31 wherein said shaped conduit is made of an elastomeric material.

33. The actuator assembly of claim 31 wherein said flow diverter functions as a venturi for slowing said fluid flow entering said accumulator.

34. The actuator assembly of claim 30 wherein said shaped conduit is integrally formed to said first portal, said shaped conduit extending in a substantially horizontal direction.

35. The actuator assembly of claim 20 wherein said flow diverter decelerates said hydraulic fluid when entering said accumulator to inhibit a high pressure hydraulic fluid flow from breaking a surface of hydraulic fluid stored in said accumulator.

36. The actuator of claim 35 further comprising a second portal disposed on a bottom surface of said accumulator for allowing hydraulic fluid to exit said accumulator to said high pressure chamber.

37. The actuator of claim 36 wherein said second portal is centrally formed on said bottom surface of said accumulator juxtaposed to said high pressure accumulator.

38. The actuator of claim 37 further comprising a fence portion disposed around said second portal for minimizing gas bubbles suspended in said hydraulic fluid of said accumulator from entering said second portal.

39. An anti-aeration system for a gas and fluid filled reservoir in a hydraulic suspension actuator, said actuator is hydraulically operated for controlling a roll of a vehicle, said actuator being connected between a first mass of said vehicle and a second mass of said vehicle, said actuator including an upper mount assembly coupled to said first mass of said vehicle, a lower mount assembly coupled to said second mass of said vehicle, a high pressure chamber disposed between said lower mount assembly and said upper mount assembly, said high pressure chamber having a variable volume of hydraulic fluid disposed therein for selectively dampening said movement between said upper mount assembly and said lower mount assembly, a low pressure accumulator including a first portal for selectively receiving hydraulic fluid from said high pressure chamber and a second portal disposed on a bottom surface of said accumulator for allowing hydraulic fluid to exit from said accumulator to said high pressure chamber, said anti-aeration system comprising:
a flow diverter for redirecting a flow of hydraulic fluid within said accumulator wherein said flow diverter minimizes the formation gas bubbles in said hydraulic fluid within said accumulator;
a fence portion disposed around said second portal for minimizing gas bubbles suspended in said hydraulic fluid of said accumulator from entering said second portal.
